(19) United States
(12) Patent Application Publication
(10) Pub. No.: US 2004/0139477 A1
(43) Pub. Date: Jul. 15, 2004

(54) 60 GHz RF CATV repeater

(76) Inventors: David B. Russell, Brookline, NH (US); Thomas Rosa, Danvers, MA (US); Robert C. Bir, Dracut, MA (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/346,012

(22) Filed: Jan. 15, 2003

(51) Int. Cl. H04N 7/173; H04N 7/20; H04N 7/16

(52) U.S. Cl. 725/126; 725/119; 725/127; 725/62; 725/63

(57) ABSTRACT

A method and system for extending the reach of cable television (CATV) broadcast networks via 60 GHz (nominally) wireless radio frequency (RF) repeaters. An original CATV AML broadcast signal, having a bandwidth of 55-860 MHz, is up-converted to a millimeter wavelength RF signal having a nominal base frequency of 60 GHz (57-64 GHz) such that the up-converted signal has a bandwidth of the base frequency plus the bandwidth of the CATV broadcast signal (e.g., 60.055-60.860 GHz). This up-converted signal is then transmitted from a transmitter antenna to a receiver antenna, which collectively define the end points of a point-to-point wireless link between network nodes. The up-converted signal is then down converted at the receiver end to produce a repeated CATV AML broadcast signal having substantially the same characteristics as the original signal. The radio transmission operations may be performed in accordance with FCC part 15.255 transmissions, enabling unlicensed operation.

### FIELD OF THE INVENTION

The field of invention relates generally to television broadcast infrastructures and, more specifically but not exclusively relates to a method and system for extending the reach of a cable television (CATV) network using a 60 GHz (nominal) radio frequency link.

### BACKGROUND INFORMATION

Cable television networks are used to provide television broadcast signals to end uses via a wired (e.g., co-axial cable) infrastructure. As such, In order to expand the reach of an existing CATV network, it is necessary for the cable service provider to either install new cable or lease existing cable infrastructure. This can become problematic and extremely expensive under various circumstances, such as in densely populated areas (i.e., downtown areas), or when physical obstacles exist, such as waterways, mountainous terrain, lack of presence of similar infrastructure (e.g., telecommunication infrastructure), etc.

One technique for addressing this problem is to provide a wireless link between network nodes that would otherwise be difficult or impractical to connect. Typically, these wireless links are facilitated by 13 or 18 GHz microwave transmitter/receiver systems, examples of which are manufactured by AML Wireless, Winnipeg, Manitoba. Transmission at 13 GHz, also known as CARSBAND, must be licensed from the Federal Communication Commission (FCC), wherein each licensee is allotted a slice of the radio frequency (RF) spectrum proximate to 13 GHz corresponding to their respective bandwidth allocation. However, traditional analog television broadcast signal bandwidth, which ranges from 55-860 MHz, is greater than the bandwidth allocated to each licensee. As a result, in order to support the full analog television signal bandwidth, it is necessary to convert the analog CATV broadcast signal into a digital form and perform video data compression techniques in real time to transmit the CATV signal content via a 13 GHz link, which requires sophisticated and expensive processing equipment at both the transmitter and receiver. Although nominally not as restrictive in bandwidth slice, the lack of spectrum re-use in combination with limited licenses under 18 GHz operations imparts a practical limitation which likewise requires digital conversion and compression of the analog CATV broadcast signal for 18 GHz microwave link transmissions in order to repeat the entire CATV broadcast signal bandwidth. As a result, these commercially available 13 and 18 GHz microwave system solutions are generally only employed as part of a primary link in which a large number of customers are linked to the CATV network at the receiving end. In fact, microwave links are sometimes used to connect a CATV head-end to a network trunk.

The availability of the foregoing wireless link solutions still leaves a wide gap between current CATV network reaches and those desired by many customers. In short, unless there is a large number of customers demanding service, CATV cable operators will not implement 13 or 18 GHz wireless links. Furthermore, since both of these frequencies correspond to licensed portions of the radio spectrum that have already been purchased (in nearly all markets), new cable service providers are excluded from entry into this market segment, thus leaving expansion decisions to the discretion of existing licensees. What is needed is a lower-cost wireless link technology for CATV broadcast transmission that can be easily implemented without substantial capital costs. Furthermore, it would be advantageous if such technology could be employed by new entrants into the cable service provider market, without the license restrictions imposed by conventional CATV transmission extension techniques.

### SUMMARY OF THE INVENTION

In accordance with aspects of the present invention a method and system are disclosed herein for extending the reach of cable television (CATV) broadcast networks via 60 GHz (nominal) wireless radio frequency (RF) repeaters. Under the method, an original CATV AML (amplitude modulated link) broadcast signal, having a bandwidth of 55-860 MHz, is transmitted via conventional cable infrastructure to a transmitter. The original broadcast signal is then up-converted to a millimeter wavelength RF signal having a bandwidth of the up-converted base frequency plus the bandwidth of the CATV broadcast signal (e.g., 60.055-60.860 GHz) via mixing with a first local oscillator signal having a frequency corresponding to the up-converted base frequency. This up-converted signal is then transmitted from the transmitter's antenna to a corresponding receiver antenna, which collectively define the end points of a point-to-point wireless link between network nodes in the extended CATV network. The up-converted signal is then down converted at the receiver via mixing with a second local oscillator signal having the up-converted signal base frequency to produce a repeated CATV AML broadcast signal having substantially the same characteristics as the original signal at the receivers output.

In another aspect of the present invention, the radio transmission operations corresponding to the 60 GHz radio transmission are performed in accordance with FCC part 15.255 transmissions, which covers RF transmission from 57.05-64.0 GHz. Since operations under part 15.255 do not require a license, the invention enables entry of new participants into cable service provider markets that were previously precluded from entry due to the aforementioned licensing restrictions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a graph illustrating the specific attenuation of millimeter wavelength radio signals due to atmospheric conditions;

FIG. 2 is a graph illustrating the average atmospheric absorption of millimeter waves for water and oxygen molecules;

FIG. 3 is a diagram illustrating potential working and frequency re-usage of millimeter fixed links;

FIG. 4 is a schematic diagram illustrated an extended CATV network employing one or more 60 GHz RF repeaters in accordance with aspects of the invention;

FIG. 5 is a schematic diagram of a 60 GHz RF repeater transmitter in accordance with one embodiment of the invention; and

FIG. 6 is a schematic diagram of a 60 GHz RF repeater receiver in accordance with one embodiment of the invention.

### DETAILED DESCRIPTION OF PREFERRED EMBODIMENTS

Embodiments of method and apparatus for extending the reach of a CATV network via wireless links are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, methods and infrastructure are disclosed herein for extending the reach of CATV networks using millimeter wave band radio signals. In particular, the infrastructure employs one or more wireless repeaters that include a transmitter that up-converts an analog CATV signal to a base transmission frequency of 60 GHz (nominally), transmits the up-converted signal to a receiver, which then down converts the signal back to its original analog waveform. Unlike conventional microwave CATV links, there is no need for digital conversion and compression of the CATV signals, eliminating the need for the complex equipment for performing these operations. As a result, the invention enables wired CATV networks to be extended at a significantly reduced cost when compared with conventional microwave systems. Furthermore, since 60 GHz transmissions fall within an unlicensed frequency band, the prior licensed-only provider restriction is removed, enabling easy entry into this segment of the CATV provider market.

The spectrum between 30 GHz and 300 GHz is referred to as the millimeter wave band because the wavelengths of these frequencies are about one to ten millimeters. Planning for millimeter wave spectrum use must take into account the propagation characteristics of radio signals at this frequency range. While signals at lower frequency bands can propagate for many miles and penetrate more easily through buildings, millimeter wave signals can travel only a few miles or less and do not penetrate solid materials very well. However, these characteristics of millimeter wave propagation are not necessarily disadvantageous. Millimeter waves can permit more densely packed communications links, thus providing very efficient spectrum utilization, and they can increase security of communication transmissions.

The frequency and distance dependence of the loss between two isotropic antennas (theoretical antennas that radiate in all directions with a gain of unity) is expressed in absolute numbers by the following equation:

L_{FSL}=(4πR/λ)² (1)

where R is the distance between transmit and receive antennas and λ: is the operating wavelength. After converting equation 1 to units of frequency and putting the result into dB form, the equation becomes:

L_{FSL dB}=92.4+20 log f+20 log R (2)

where f is frequency in GHz and R is the Line-of-Sight range between antennas in kilometers.

In accordance with equation 2, for every octave change in range, the differential attenuation changes by 6 dB. For example, in going from a 2-kilometer to a 4-kilometer range, the increase in loss is 6 dB. Note that even for short distances, the free space loss can be quite high. This suggests that for applications of millimeter wave spectrum, only short distance communications links will be supported.

In microwave systems, transmission loss is accounted for principally by the free space loss. However, in the millimeter wave bands additional loss factors come into play, such as gaseous losses and rain in the transmission medium. Other factors that affect millimeter wave propagation include foliage blockage, scattering effects, and diffraction.

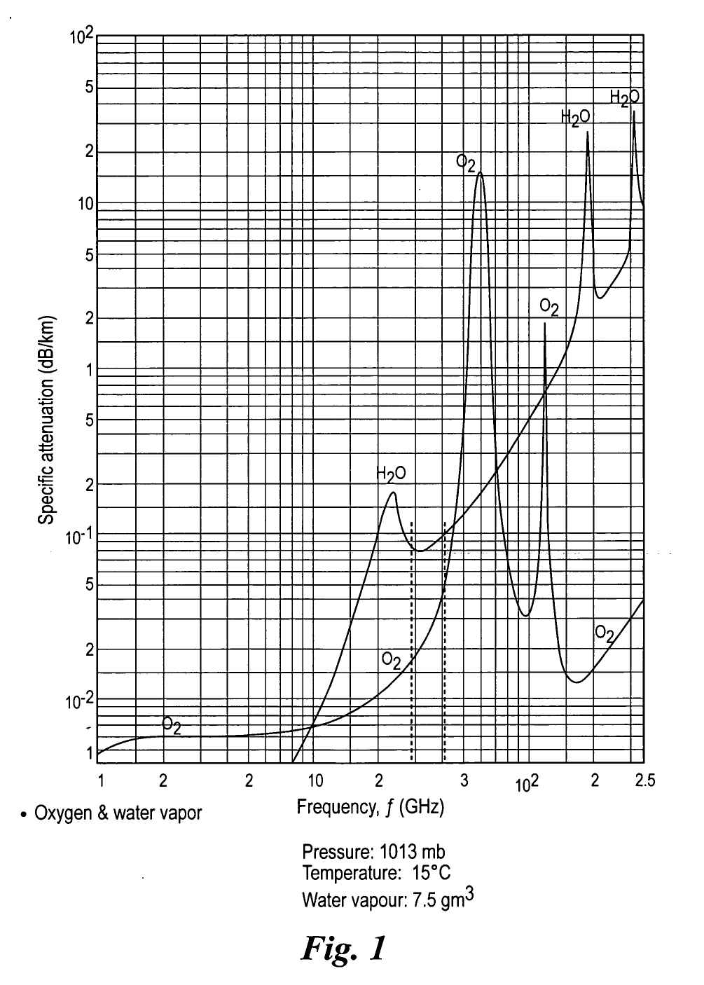

Transmission losses occur when millimeter waves traveling through the atmosphere are absorbed by molecules of oxygen, water vapor and other gaseous atmospheric constituents. These losses are greater at certain frequencies, coinciding with the mechanical resonant frequencies of the gas molecules. FIG. 1 provides qualitative data on such gaseous losses for radio signals having millimeter wavelengths. The diagram shows several peaks that occur due to absorption of the radio signal by water vapor (H₂O) and oxygen (O₂). At these frequencies, absorption results in high attenuation of the radio signal and, therefore, short propagation distance. For current technology the important absorption peaks occur at 24 and 60 GHz. The spectral regions between the absorption peaks provide windows where propagation can more readily occur. The transmission windows are at about 35 GHz, 94 GHz, 140 GHz and 220 GHz.

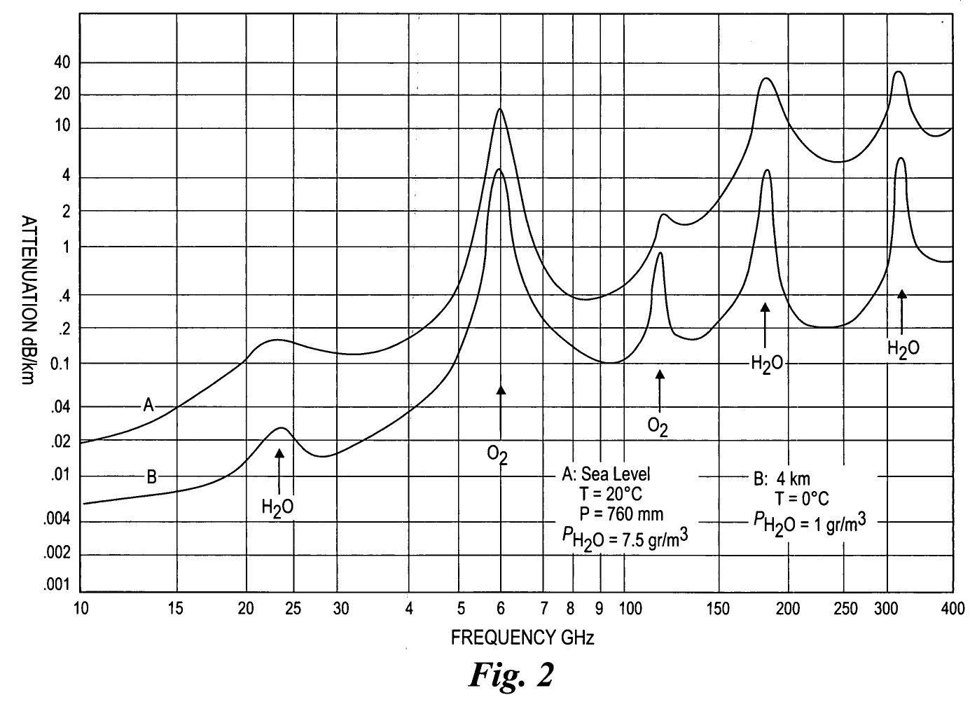

The H₂O and O₂ resonances have been studied extensively for purposes of predicting millimeter propagation characteristics. FIG. 2 shows an expanded plot of the atmospheric absorption versus frequency at altitudes of 4 km and sea level, for water content of 1 gm/m³ and 7.5 gm/m³, respectively (the former value represents relatively dry air while the latter value represents 75% humidity for a temperature of 10° C.).

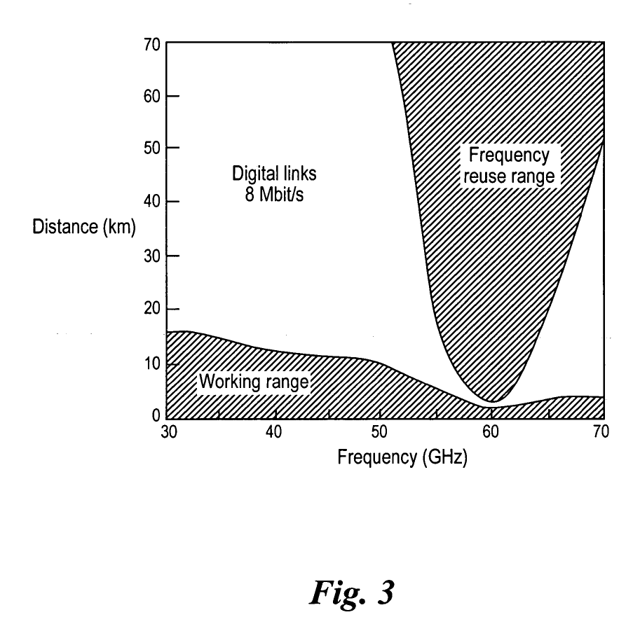

It is clear from FIGS. 1 and 2 that the effect of transmission losses due to O₂ resonances is substantially greater at 60 GHz than at other frequencies. Although use of this frequency may at first seem disadvantageous due to these transmission losses, the foregoing propagation characteristic enables many communication links to operate concurrently in close proximity with minimal cross-channel interference. This is qualitatively illustrated in FIG. 3, which depicts frequency reuse possibilities, based on atmospheric gaseous losses, for typical fixed service systems operating in the vicinity of 60 GHz. (While FIG. 3 depicts data corresponding to digital links operating at 8 Mbits/second, the principles illustrated are generally applicable to analog signal transmissions as well). The upper portion of FIG. 3 depicts the frequency re-use range, while the lower portion of FIG. 3 depicts the potential working range of RF links from 30-70 GHz, which corresponds to the average maximum distance over which a typical fixed link can operate. Where two links employ the same frequency (i.e., frequency re-use), if they are separated by a distance greater than the frequency re-use range, it will be certain that mutual interference will be at an acceptable level or below. Note that at the 60 GHz oxygen absorption peak, the working range for a typical fixed service communications link is very short, on the order of 2 km, and that another link could be employed on the same frequency if it were separated from the first link by about 4 km. In contrast, at 55 GHz, the working range for a typical fixed service link is about 5 km, but a second link would have to be located about 18 km away to avoid interference.

In general, the ranges are influenced by the attenuation of the radio waves in the intervening space, being shorter in cases of high attenuation. If the two links are separated by less than the re-use distance, detailed calculations are necessary to determine whether various other factors will provide sufficient protection from mutual interference. For instance, other factors to be considered in determining actual frequency reuse may include antenna directivity and intervening obstacle path loss. In particular, wireless links operating in this frequency band need to provide extremely unidirectional signals, requiring corresponding transmitter and receiver antennas.

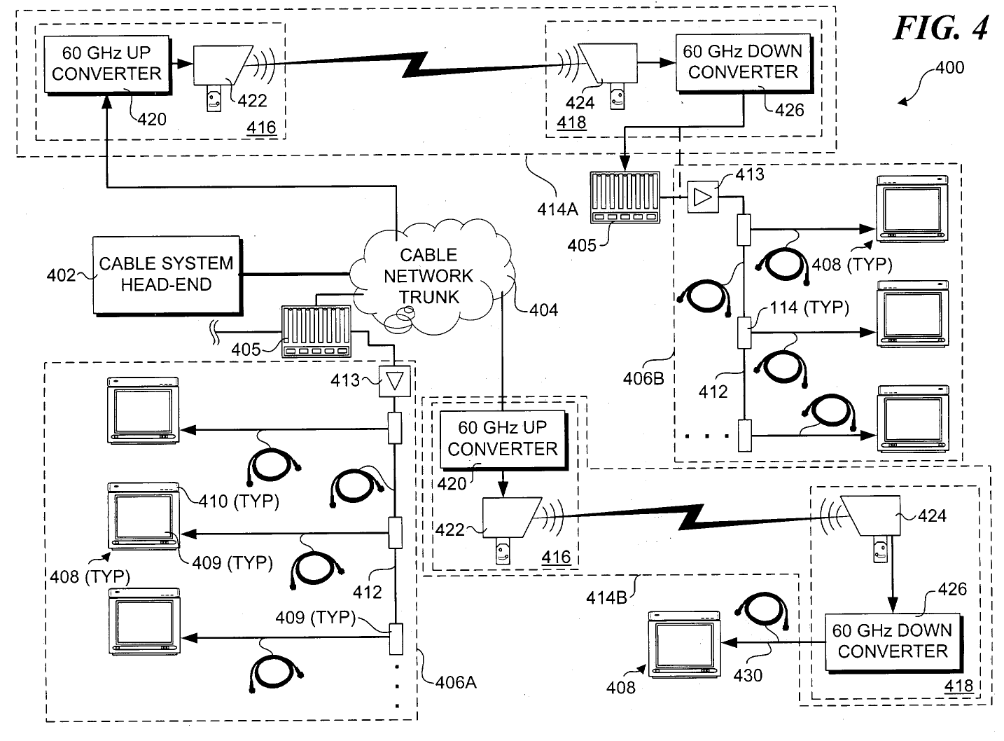

An overview of a CATV network 400 infrastructure employing wireless links in accordance with aspects of the present invention is shown in FIG. 4. The CATV network includes conventional components and systems that are well-known in the CATV art, including a cable system head-end 402, which provides television broadcast signals that are distributed to cable subscribers via a cable network. The cable network infrastructure is designed to distribute television broadcast signals having a general range of 55-860 MHz to various customer premise equipment (CPE), and includes a cable network trunk 404 (depicted as a network cloud for simplicity) to which a plurality of hubs 405 are connected. Additional cable infrastructure equipment may include repeaters, amplifiers, splitters, etc. Each hub will typically be connected to a plurality of sub-networks (sub-nets) 406. In turn, each sub-net will include distribution equipment to provide the broadcast television signals to a plurality of customer premise equipment 408, such as televisions 409, and set-top boxes 410. Generally, the distribution equipment in a sub-net will include co-axial cable 412 routed between various amplifiers 413 and splitters 414. If the sub-net is large, it may further include one or more repeaters and the like.

In accordance with aspects of the invention, the reach of existing CATV networks may be extended via one or more 60 GHz radio frequency (RF) repeaters. Exemplary RF repeaters of this type are shown as 60 GHz RF repeaters 415A and 415B in FIG. 4. Each RF repeater includes a transmitter 416 and a receiver 418. Each transmitter 416 includes a 60 GHz up-converter 420 and a 60 GHZ RF transmitter antenna 422. Each receiver 418 includes a 60 GHZ RF receiver antenna 424 and a 60 GHz down-converter 426. The receiver 418 for 60 GHz RF repeater 414A provides an output that is connected to a cable sub-net 406B, while the receiver 418 for 60 GHz RF repeater 414A provides an output that is transmitted via a cable 430 to a single CPE 408. A receiver may be connected directly to a sub-net, or to a hub, which in turn may be connected to one or more subnets.

The base transmission frequency (60 GHz) of the repeater's RF link corresponds to an unlicensed band for RF communications as defined by FCC part 15.255. More specifically, FCC part 15.255 specifies that the RF spectrum from 57.05-64 GHz is an unlicensed band that may be used for RF transmission of signals under a particular set of conditions. (Accordingly, as used herein, the terminology 60 GHz or “nominally” 60 GHz refers to RF transmissions anywhere within the general range 57-64 GHz.) In order to qualify under the set of conditions, RF transmissions under FCC part 15.255 must be very unidirectional (due to RF propagation characteristics in this frequency range discussed above) and the corresponding links will have limited length due to the power limitations defined by the FCC regulation and the propagation characteristics.

Although some of the implications of operating under FCC part 15.255 may first appear as limitations, there are several key benefits. First, since the transmission power is limited and the signals are unidirectional, there will be substantially no interference between respective signals transmitted over various links, even when the links are in close proximity, thus facilitating extensive re-use of the spectrum. These characteristics enables RF operation under this part to be unlicensed, meaning it is not necessary to obtain an FCC license to transmit RF signals when operating under part 15.255. Additionally, the transmitted signals are highly secure and difficult to intercept. Due to the unidirectional quality of the signals, an intercepting receiver would need to be located in very close proximity to the target receiver, and thus could be easily identified. Furthermore, since the transmissions are highly secure, there is no need to scramble the transmitted signals, which is generally necessary under conventional RF transmission of broadcast signals, such as that employed by satellite TV networks and some microwave CATV links.

As discussed above, the limited bandwidth of the licensed frequency slices corresponding to microwave CATV systems operating under 13 and 18 GHz requires an expensive conversion of the original analog CATV broadcast signal into a compressed digital form in order to support extension of the traditional CATV signal frequency range of 55-860 MHz. In contrast, since part 15.255 operations are unlicensed, there are no such bandwidth slice limitations, enabling direct up-conversion and down-conversion of the original analog broadcast signal. This significantly lowers the cost of the system equipment.

Another advantage of the invention's 60 GHz wireless repeater scheme is that the antennas employed for the transmitter and receiver are significantly smaller than comparable microwave equipment. This is due to the fact that the minimum antenna diameter for a given frequency is a function of the signal wavelength (e.g., minimum diameter=¼ λ); since microwaves are longer than millimeter waves, microwave systems require proportionally larger diameter antennas. Furthermore, since the area of an antenna is related to the square of its diameter, the required area for a 60 GHz antenna is approximately 21 times smaller than that for a 13 GHz antenna and 11 times smaller than that for an 18 GHz antenna.

As discussed above, the propagation characteristics of 60 GHz radio signals and the power limitations proscribed by part 15.255 require radio transmission links that are very unidirectional. For example, such links should generally have a transmitted radio signal width (usually quantified at 3 dB, also called directivity) of only a few degrees at most (e.g., <4°), and preferably about one degree or less. Historically, transmission equipment in the 60 GHz band has been restricted to military implementations, with no to limited commercial availability. Recently, advanced 60 GHz transmission equipment has been introduced for commercial markets. Examples of this equipment includes 60 GHz transmitters, receivers, and transceivers manufactured by Terabeam Corporation, Redmond Wash., under the Gigalink™ trademark. In a preferred embodiment, the transmitter and receiver antennas are substantially similar to corresponding antennas employed for Terabeam's Gigalink™ model 6421e system. The 6421e model employs 13″ parabolic antennas and provides radio signals having a directivity (beam width) of 1° at 3 dB. In another embodiment, the transmitter and receiver antennas may be substantially similar to corresponding antennas employed for a Gigalink™ model 6221e system. In this instance, the antennas are integral patch array types and employ radio signals having a directivity of approximately 3.5° at 3 dB.

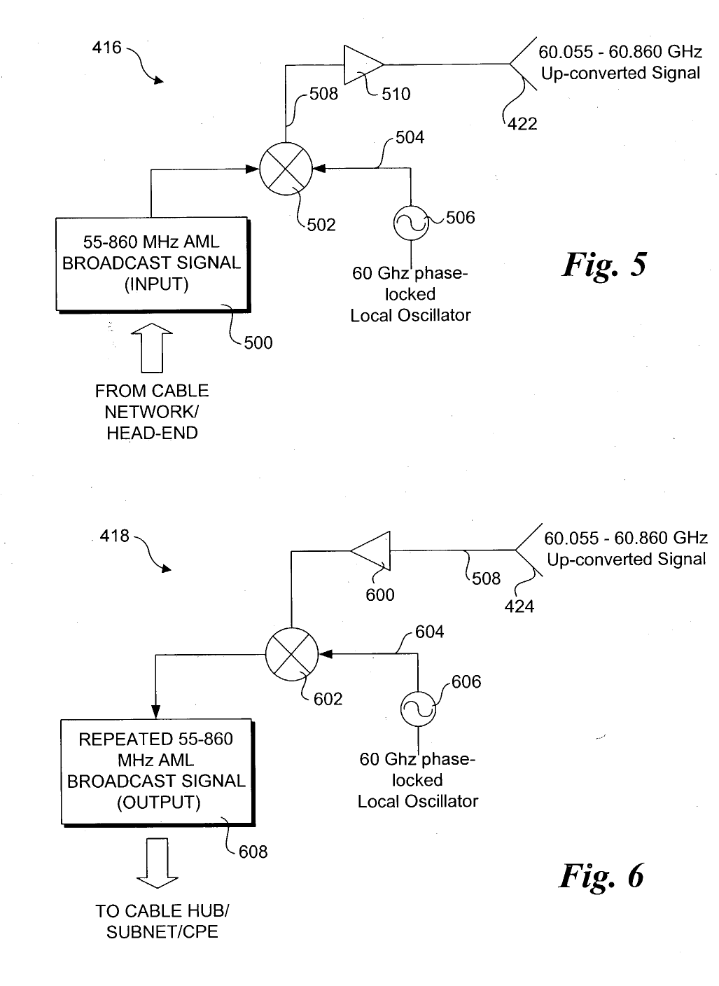

Further details of transmitter 416 are shown in FIG. 5. The transmitter receives a 55-860 MHz analog AML broadcast signal 500 from the cable network. In general, the broadcast signal may be provided at the network head-end, trunk, or via one of the network hubs. In one embodiment, the broadcast signal is provided via an RG-59 interface including a corresponding input connector. The 55-860 MHz broadcast signal is received as one of two inputs by a single sideband mixer 502. The other signal received by the mixer is a 60 GHz phase-locked local oscillation signal 504 generated by a signal generator 506. The single sideband mixer multiplies its received signals to produce an up-converted signal 508 having a frequency of 60.055-60.850 GHz. Up-converted signal 508 is then amplified via an amplifier 510 and transmitted from 60 GHz RF transmitter antenna 422 to be received at 60 GHz RF receiver antenna 424.

With reference to FIG. 6, upon receiving the up-converted signal 512, the signal is passed through an amplifier 600 and is received as a first input by a single side-band mixer 602. A 60 GHz phase-locked local oscillation signal 604 produced by a signal generator 606 is received by the mixer as a second input. The mixing of the 60 GHz phase-locked local oscillation signal 606 and the filtered up-converted signal 602 down-converts the up-converted signal to yield a repeated CATV AML broadcast signal 608 having amplitude and bandwidth characteristics substantially similar to the original CATV AML broadcast signal 500. The repeated CATV broadcast signal can then be transmitted to various CPE via applicable networking infrastructure. Optionally, a receiver may be configured to provide direct input to customer premise equipment.

It is noted that up- and down-conversion converters having similar components and functions may be employed in place of those illustrated in FIGS. 5 and 6. For instance, other types of mixers may be employed in place of the single side-band mixers discussed above in conjunction with applicable filters, such as a band-pass filter for the up-converted signal and a low-pass or intermediate filter for the down-converted signal.

Thus, a method and system components have been disclosed to enable extension of CATV broadcast networks to previously untapped customers via one or more 60 GHz wireless repeaters. The disclosed technology provides several advantages over the prior art microwave systems, including substantially reduced costs and the removal of licensing constraints that have effectively locked out potential competitors from many CATV markets.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A wireless cable television (CATV) broadcast signal repeater, comprising:
an up-converter, to receive an original CATV amplitude modulated link (AML) broadcast signal having an original form and up convert the signal to a millimeter wavelength up-converted signal having a nominal base frequency of 60 gigahertz (GHz);
a transmitter, operatively coupled to the up-converter, to transmit the up-converted signal via free space;
a receiver antenna, to receive the transmitted up-converted signal from the transmitter; and
a down-converter, operatively coupled to the 60 GHz receiver antenna, to down convert the up-converted signal to produce a repeated CATV AML broadcast signal substantially matching the original CATV AML broadcast signal,
wherein the nominal 60 GHz base frequency corresponds to a frequency within the range of 57-64 GHz and the transmitter and receiver antennas operate at a corresponding frequency.

2. The wireless CATV broadcast signal repeater of claim 1, wherein the up-converter comprises:
an input connector, to couple the up-converter to a cable carrying the original CATV AML broadcast signal;
a local oscillator to generate a nominal 60 GHz phase-locked signal; and
a mixer having a first input coupled to the input connector to receive the CATV AML broadcast signal, a second input coupled to receive the nominal 60 GHz phase-locked signal from the local oscillator, and an output, said mixer producing an up-converted signal having a nominal base frequency of 60 GHz at the output.

3. The wireless CATV broadcast signal repeater of claim 1, wherein the down-converter comprises:
an up-converted signal input, coupled to receive the up-converter signal from the receiver antenna;
a local oscillator to generate a nominal 60 GHz phase-locked signal; and
a mixer having a first input coupled to the up-converted signal input connector to receive the up-converted signal, a second input coupled to receive the nominal 60 GHz phase-locked signal from the local oscillator, and an output, said mixer producing the repeated CATV AML broadcast signal at its output.

4. The wireless CATV broadcast signal repeater of claim 3, wherein the down-converter further includes an amplifier disposed between the up-converted signal input and the first input of the mixer.

5. The wireless CATV broadcast signal repeater of claim 1, wherein the repeated CATV AML broadcast signal has a bandwidth of 55-860 MHz.

6. The wireless CATV broadcast signal repeater of claim 1, wherein the transmitter antenna transmits the up-converted signal as a unidirectional radio signal having a directivity of 1° or less at 3 dB.

7. The wireless CATV broadcast signal repeater of claim 1, wherein the transmitter antenna transmits the up-converted signal as a unidirectional radio signal having a directivity of 4° or less at 3 dB.

8. The wireless CATV broadcast signal repeater of claim 1, wherein the up-converted signal is transmitted between the transmitter and receiver antennas in accordance with radio transmission operations defined by FCC part 15.255.

9. A cable television (CATV) network, comprising:
a head end, to transmit an original CATV amplitude modulated link (AML) broadcast signal having an original form; and
a wireless CATV broadcast signal repeater, comprising:
an up-converter including an input operatively linked to the head end via cable infrastructure, to receive the original CATV AML broadcast signal and up convert the signal to an millimeter wavelength up-converted signal having a nominal base frequency of 60 gigahertz (GHz);
a transmitter antenna, operatively coupled to the up-converter, to transmit the up-converted signal via free space;
a receiver antenna, to receive the transmitted up-converted signal from the transmitter antenna; and
a down-converter, operatively coupled to the receiver antenna, to down convert the up-converted signal to produce a repeated CATV AML broadcast signal substantially matching the original CATV AML broadcast signal at an output to which one of a CATV sub-network or customer premise equipment may be operatively coupled via cable infrastructure,
wherein the nominal 60 GHz base frequency corresponds to a frequency within the range of 57-64 GHz and the transmitter and receiver antennas operate at a corresponding frequency.

10. The CATV network of claim 9, wherein the CATV AML broadcast signal has a bandwidth of 55-860 MHz.

11. The CATV network of claim 9, wherein the up-converted signal is transmitted between the transmitter and receiver antennas in accordance with radio transmission operations defined by FCC part 15.255.

12. The CATV network of claim 9, wherein the cable infrastructure includes a hub linked to the head end via a network trunk, said hub coupled to the input of the up converter.

13. The CATV network of claim 9, wherein the network includes a plurality of wireless CATV broadcast signal repeaters.

14. A method for extending the reach of a cable television (CATV) network, comprising:
providing an original CATV amplitude modulated link (AML) broadcast signal to a first network node;
transmitting the CATV AML broadcast signal from the first network node to a second network node via a wireless link by performing operations including,
up converting the original CATV AML broadcast signal to a millimeter wavelength up-converted signal having base frequency of 57-64 GHz,
transmitting the up-converted signal between a transmitter antenna operatively coupled to the first network node and a receiver antenna operatively coupled to the second network node;
down-converting the up-converted signal to produce a repeated CATV AML broadcast signal having waveform characteristics substantially similar to the original CATV AML broadcast signal; and
outputting the repeated CATV AML broadcast signal to the second network node.

15. The method of claim 14, wherein the CATV AML broadcast signal has a bandwidth of 55-860 MHz.

16. The method of claim 14, wherein the up-converted signal is transmitted between the transmitter and receiver antennas in accordance with radio transmission operations defined by FCC part 15.255.

17. The method of claim 14, wherein the transmitter antenna transmits the up-converted signal as a unidirectional radio signal having a directivity of 1° or less at 3 dB.

18. The method of claim 14, wherein the 60 GHz transmitter antenna transmits the up-converted signal as a unidirectional radio signal having a directivity of 1° or less at 3 dB.

19. The method of claim 14, wherein original CATV AML broadcast signal is up-converted by mixing the original CATV AML broadcast signal with a local oscillator phase locked signal having a frequency corresponding to the up-converted signal base frequency.

20. The method of claim 14, wherein the up-converted signal is down converted by mixing the up-converted signal with a local oscillator phase locked signal having a frequency corresponding to the up-converted signal base frequency.
